(19) United States
(12) Patent Application Publication
(10) Pub. No.: US 2002/0106569 A1
(43) Pub. Date: Aug. 8, 2002

(54) Method for forming a printing plate in printing machines

(76) Inventor: Arndt Jentzsch, Coswig (DE)

Correspondence Address: GOODWIN PROCTER & HOAR LLP, 7 BECKER FARM RD, ROSELAND, NJ, 07068, US

(21) Appl. No.: 09/947,970

(22) Filed: Sep. 6, 2001

(30) Foreign Application Priority Data
Sep. 8, 2000 (DE) DE 100 39 820.0

(51) Int. Cl. G03G 13/32

(52) U.S. Cl. 430/49; 430/125

(57) ABSTRACT

The invention relates to process generating a the printing image carrying printing form on a printing form cylinder in a printing press.

Task of the invention is to establish a process to generate an erasable printing form on the printing form cylinder of a printing press with low expenditure and high life expectancy.

The task is solved according to the invention with the printing form cylinder having a magetizeable surface, which can be image carrying magnetized and be coated with toner. The toner adheres to the printing form cylinder. Printing is done with the so created printing form. The toner will be erased from the printing form cylinder through a laser after printing.

### FIELD OF INVENTION

The invention relates to process generating a the printing image carrying printing form on a printing form cylinder in a printing press.

### BACKGROUND OF INVENTION

A process to generate a printing form in the printing press of offset presses, especially offset presses with dampening units, with hydrophob image areas taking the printing ink and hydrophile areas influencing the affinity to water is known in DE 4119111 A1. In this process at least one nozzle connected to a reservoir generates small droplets of a oleophil and water resistant coating material in form of dots or matrices adequate to the image on a hydrophile printing form cylinder surface. The nozzle moves in line direction and the printing form cylinder perpendicular to this movement. A central control unit receives the digital image information from an information media and transfers the control signals through a transfer unit and control unit to the nozzle and the printing form cylinder.

Furthermore the Xerox copy process is generally known. In this process a latent image is generated on a semi-conductor drum, transferred with a powdery toner to a paper sheet and the latent image is erased. This process can not be used in a printing machine.

### SUMMARY DESCRIPTION OF INVENTION

Task of the invention is to establish a process to generate an erasable printing form on the printing form cylinder of a printing press with low expenditure and high life expectancy.

The task is solved according to the invention with the printing form cylinder having a magetizeable surface, which can be image carrying magnetized and be coated with a toner. The toner adheres to the printing form cylinder. Printing is done with the so created printing form. The toner will be erased from the printing form cylinder through a laser after printing.

### BRIEF DESCRIPTION OF THE DRAWINGS

The invention is described below in greater detail by an embodiment of the invention, by reference being had to the drawing, wherein:

FIG. 1: Printing form cylinder with erasing unit

FIG. 2: Printing form cylinder with magnetizing unit

FIG. 3: Printing form cylinder with device for applying of toner

FIG. 4: Printing form cylinder with compacting unit

### DETAILED DESCRIPTION

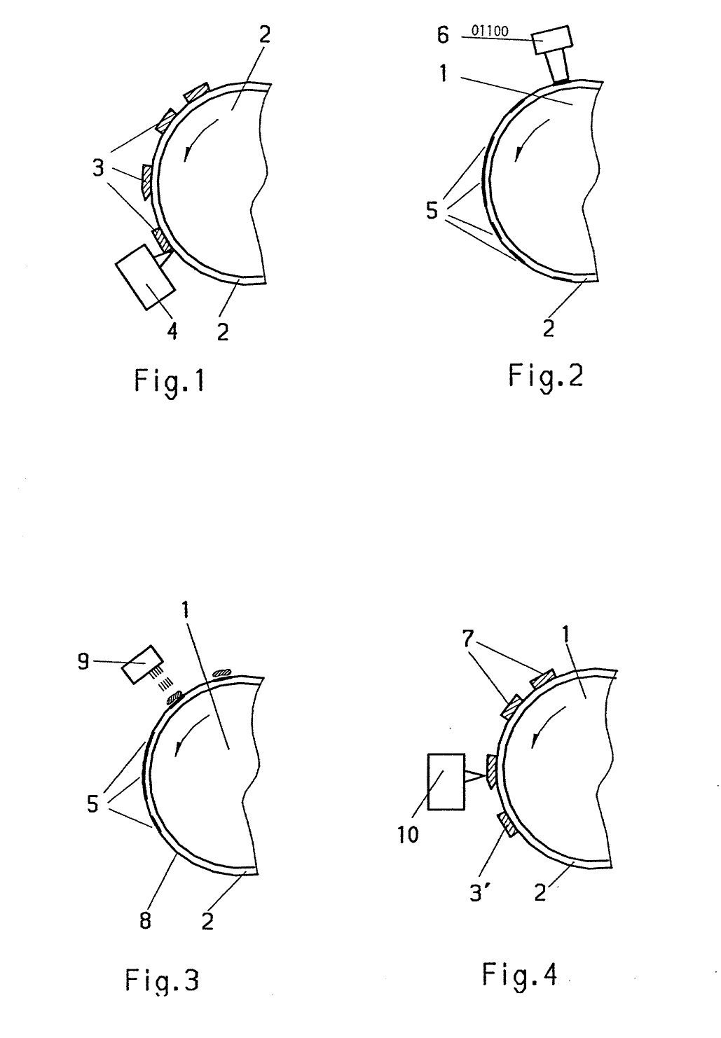

FIG. 1 shows the printing form cylinder in a printing press. The printing form cylinder 1 has a magnetizeable surface 2 with suitable hydrophile characteristic. The semi-conductor surface 2 has image carrying locations 3 from the preceding printing job. These image carrying locations 3 are hydrophob.

The image carrying locations 3 of the preceding printing job must be removed before new image carrying location 3′ are applied to the printing cylinder 1. They are removed by an erasing unit 4 allocated to the printing form cylinder 1. The erasing unit 4 operates with a laser and traverses or reaches over the entire width of the printing form cylinder 1.

FIG. 2 shows the process step magnetizing of the new image carrying locations 3′ on the magnetizeable surface 2. The new image carrying locations 3′ are magnetized for a new printing job with a magnetizing unit 6. The magnetizing makes the magnetized locations 5 receptive for the later applied toner 7. The magnetizing unit 6 is connected with a not shown memory unit for the digital matrix of the image carrying locations.

The magnetizing unit 6 traverses or reaches similar to the erasing unit 4 over the entire width of the printing form cylinder 1.

In the next process step shown in FIG. 3 the toner 7 is applied to the magnetizeable surface 2 of the printing form cylinder 1. The toner 7 is preferably powdery but can also be pasty or liquid. The toner 7 adheres to the magnetized locations 5 but can not adhere to the non-magnetized locations 8, which stay free of toner. The toner 7 is applied with a device for applying the toner 9. This device traverses or reaches similar to the magnetizing unit 6 over the entire width of the printing form cylinder 1.

FIG. 4 shows the last process step. A compacting unit 10 compacts the toner particles adhering to the magnetized locations 5 of the magnetizeable surface 2. The compacted toner particles are now identical with the image carrying locations 3″. The printing form is ready for printing after this process step.

We claim:

1. Process generating a printing image carrying printing form on a printing form cylinder in a printing machine, whereby the printing form cylinder has a magnetizeable surface to be magnetized for image carrying, coated with toner on the image carrying positions, the toner compacted to the printing form cylinder, printing with the generated printing form and removing the toner compacted with the printing form cylinder by a laser.

2. Process generating a printing image carrying printing form according to claim 1, whereby the toner has a powdery, pasty or liquid consistency.

3. Process generating a printing image carrying printing form according to claim 1, whereby the toner is burnt in.

4. Process generating a printing image carrying printing form according to claim 1, whereby the toner is hardened.
